(19) United States
(12) Patent Application Publication
(10) Pub. No.: US 2019/0319282 A1
(43) Pub. Date: Oct. 17, 2019

(54) Magnesium Fuel Assembly and Magnesium Battery

(71) Applicant: CIP Software Co., Ltd., Tokyo (JP)

(72) Inventors: Takashi Yabe, Tokyo (JP); Kyoko Okemoto, Tokyo (JP)

(21) Appl. No.: 16/382,109

(22) Filed: Apr. 11, 2019

(30) Foreign Application Priority Data
Apr. 12, 2018 (JP) 2018-76864

(51) Int. Cl. H01M 8/04276; H01M 4/90

(52) U.S. Cl. CPC H01M 8/04276; H01M 2004/8684; H01M 4/9041

(57) ABSTRACT

A magnesium battery, which uses oxygen in the air as the cathode active material and magnesium as the anode active material, the invention provides a simple mechanism that enables realization of a magnesium fuel assembly and a magnesium battery capable of uninterrupted fuel supply.

### PRIORITY CLAIM

This application claims benefit under Japanese Application Number 2018-76864, filed Apr. 12, 2018. The entire contents of which is hereby incorporated by reference as if fully set forth herein.

### TECHNICAL FIELD

The invention is related to magnesium fuel assemblies and magnesium batteries.

### BACKGROUND

To produce an efficient cell, a structure in which fuel is constantly supplied in succession is required. Japanese Patent Number 5034014 proposes a method of supplying fuel by winding magnesium in a film form onto a reel and rotating the reel. In addition, Japanese Patent Number 5891569 proposes a method of supplying magnesium in a thin plate form by driving a bellows mechanism. In these magnesium batteries, the cell reaction begins when magnesium in film or plate form is inserted into the cell body, and magnesium that has undergone reaction is ejected from the cell body. Reaction is sustained by then inserting new magnesium.

The supply mechanisms shown in Japanese Patent Number 5034014 and Japanese Patent Number 5891569 feature complicated structures, resulting in problems requiring large-scale drive mechanisms.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 Cross section of magnesium fuel assembly 100;

FIG. 2 Outline configuration of cross section of cathode 300 in magnesium battery 200;

FIG. 3 Drawing of outline configuration that describes the operation of magnesium battery 200;

FIG. 4 Drawing of outline configuration that describes the operation of magnesium battery 200;

FIG. 5 Drawing of outline configuration that describes the operation of magnesium battery 200;

FIG. 6 Drawing of outline configuration that describes the operation of magnesium battery 200;

FIG. 7 Outline drawing showing the shape of cathode 300 in magnesium battery 200;

FIG. 8 Outline drawing showing the shape of cathode 300 in magnesium battery 200;

FIG. 9 Cross-sectional drawing of the side of magnesium fuel assembly 500; and

FIG. 10 Cross-sectional drawing showing an outline configuration of cathode 700 in magnesium battery 600.

### EMBODIMENTS OF THE INVENTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In light of the problems involved, the purpose of the invention is to propose a magnesium fuel assembly that can be continuously supplied by a simple mechanism and a magnesium battery provided with the said magnesium fuel assembly.

The features applied to achieve the above purpose are as follows: the magnesium fuel assembly relating to the first aspect of the invention is provided with a separator formed with liquid-absorbable material, a magnesium plate incorporating magnesium encased in the aforementioned separator and a rotating shaft formed by a semiconductor electrically connected to the aforementioned magnesium plate; the aforementioned rotating axis is arranged to penetrate at a point near the center of the aforementioned magnesium plate and the aforementioned magnesium plate rotates with the aforementioned rotating shaft at its center.

The aforementioned magnesium plate may be circular in shape.

Multiple magnesium plates mentioned above are arranged sharing the aforementioned rotating shaft and the aforementioned multiple magnesium sheets may rotate with the aforementioned rotating shaft at the center.

The aforementioned rotating shaft may be furnished with an operating device.

The aforementioned operating device may be a spring wound onto an elastic body in a spiral.

The features of the magnesium battery relating to the second aspect of the invention are as follows: it consists of the magnesium fuel body relating to the first aspect of the invention, a cathode that is inserted from both sides and is in contact with part of the aforementioned magnesium plate and an electrolytic solution retainer that holds electrolytic solution inside. The aforementioned magnesium plate that serves as fuel moves by rotation of the aforementioned magnesium fuel assembly absorbs the electrolytic solution in the aforementioned electrolytic solution retainer. Then, the said magnesium plate, which is inserted into the aforementioned cathode, produces an electromotive force. After the reaction, the magnesium plate is extracted by rotation of the said cathode, at the same time as an unreacted aforementioned magnesium plate is inserted into the said cathode.

The aforementioned cathode may be fan-shaped.

Multiple aforementioned cathodes may be installed.

The invention makes it possible to provide a magnesium assembly capable of maintaining a continuous supply to the area surrounding the electrode and a magnesium battery consisting of the said magnesium fuel assembly through a simple mechanism.

Details of the embodiments of the invention are described below referring to the drawings.

### Embodiment 1

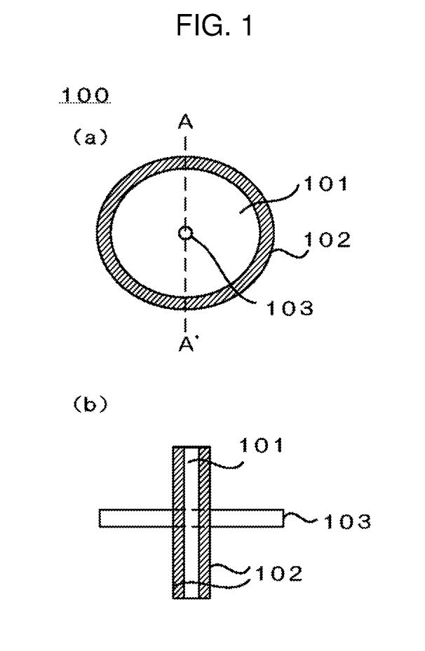

Firstly, we will describe the configuration of magnesium fuel assembly 100. FIG. 1 is a cross-sectional drawing of magnesium fuel assembly 100 showing a view seen from the axial direction of rotating shaft 103 described later (a) and a cross-sectional drawing of point A-A (b). As shown in FIG. 1, magnesium fuel assembly 100 is furnished with magnesium plate 101, separator 102 and rotating shaft 103. Magnesium fuel assembly 100 functions as the fuel for the magnesium battery.

Magnesium fuel assembly 101 is a plate formed from metallic magnesium. While in FIG. 1, the plate is disk-shaped, other shapes may be used.

Separator 102 functions as the separator for the magnesium battery. Formed from material capable of retention by and impregnation of electrolytic solution, separator 102 transmits ions required for oxidation-reduction reaction. For example, materials such as non-woven fabrics or felt may be used. Separator 102 encases magnesium plate 101.

Formed from electrically-conductive material, rotating shaft 103 penetrates separator 102 and magnesium plate 101 and functions as the rotating shaft with separator 102 and magnesium plate 101. At the same time, the shaft is electrically connected to magnesium plate 101 and functions as the anode of the magnesium battery. By serving the dual functions of a rotating shaft and electrode anode, the shaft enables a simple mechanism and can also extract electricity.

An operating device such as a motor is used as the motive force for rotation. The force produced by unwinding of a spring wound in a spiral around an elastic body, for example, can be used as the motive force. This both simplifies the device and makes it possible to adjust rotation by the time taken for the spring to unwind.

Next, we will describe magnesium battery 200, which uses magnesium fuel assembly 100 as fuel.

Magnesium battery 200 is furnished with cathode 300 and electrolyte solution retainer 400 and produces electromotive force with magnesium fuel assembly 100 as its fuel.

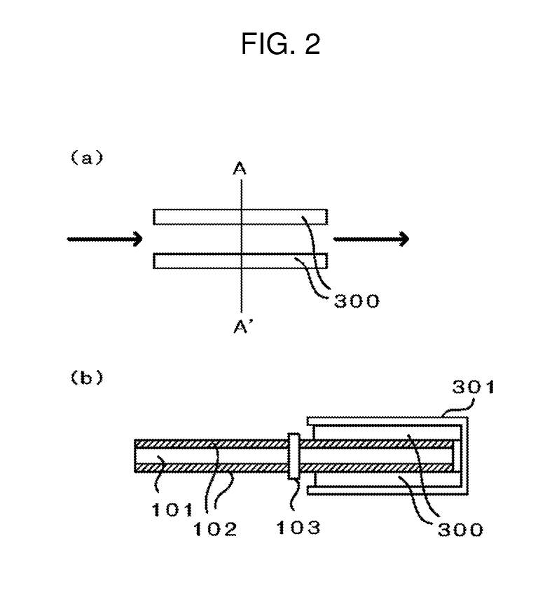

FIG. 2 is a cross-sectional drawing of the side that shows an outline configuration of cathode 300 and cross-sectional views of the appearance seen from rotating shaft 103 looking toward the circumference or the surroundings of magnesium plate 101 (a) and a cross-sectional drawing of point A-A (b). (FIG. 2 (b) also shows a part of magnesium fuel assembly 100.) The arrows in the drawing show the direction of movement of magnesium plate 101 in magnesium fuel assembly 100. Cathode 300 is arranged so that it sandwiches a part of rotating magnesium fuel assembly 100 from above and below. Cathode 300 set in place above and below is capable of passing through rotationally moving magnesium plate 101 and separator 102 and is arranged to maintain a distance at which it can make contact with separator 102. This distance may be fixed for cathode 300 and covering component 301 may be provided to function as a cover.

Formed from electrically-conductive material, cathode 300 functions as the cathode of magnesium-air cell 200. Cathode 300 supplies electrons to oxygen in the air, which is the cathode active material. While materials such as carbon, metal, manganese compounds or combinations of these may be used as the material to form cathode 300, other materials may also be used. The material should preferably have a large surface area that promotes oxygen reduction to facilitate oxygen absorption.

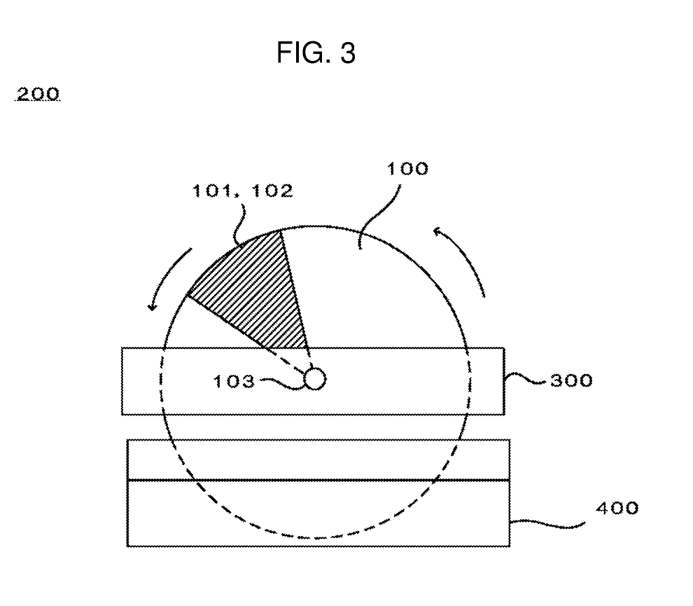

Next, we will describe an outline configuration of magnesium battery 200 using FIG. 3. FIG. 3 shows an outline configuration viewed from the axial direction of rotating shaft 103. Electrolytic solution retainer 400 holds electrolytic solution within. Electrolytic solution retainer 400 is positioned so that separator 102 that encases magnesium plate 101 in electrolytic solution retainer 400 can be impregnated with the electrolytic solution as magnesium fuel assembly 100 rotates.

The electrolytic solution allows the exchange of ions between magnesium fuel assembly 100 and cathode 300. Water contained in the electrolytic solution is used by cathode 303 in the oxygen reduction reaction. While sodium chloride aqueous solution, for example, can be used as the electrolytic solution, other solution may also be used.

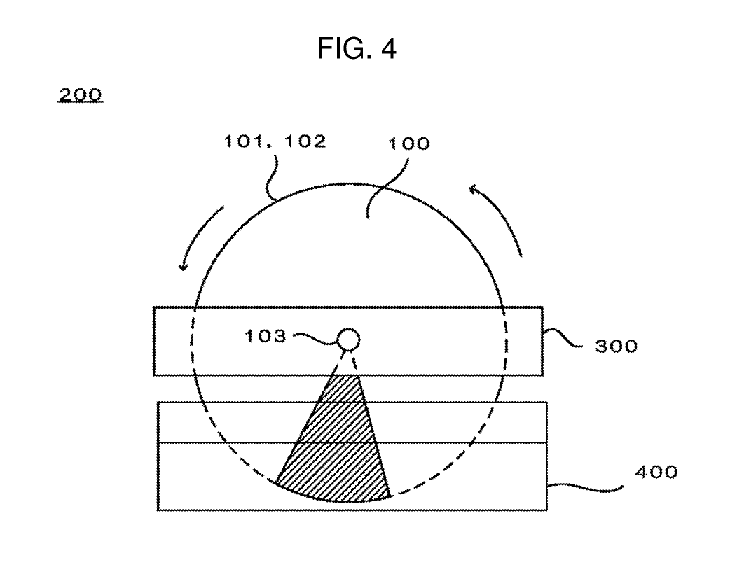

Next, we will describe the method to use magnesium fuel assembly 100 as fuel for magnesium battery 200 using FIGS. 4-6. The shaded areas in FIGS. 4-6 show parts about to be used as fuel. Note that, cathode 300 in FIGS. 4-6 is oblong-shaped so that it crosses rotating shaft 103, and while the left and right cathodes crossing rotating shaft 103 are both used for cell reactions, the descriptions below shall explain the reaction on the right side of the drawings.

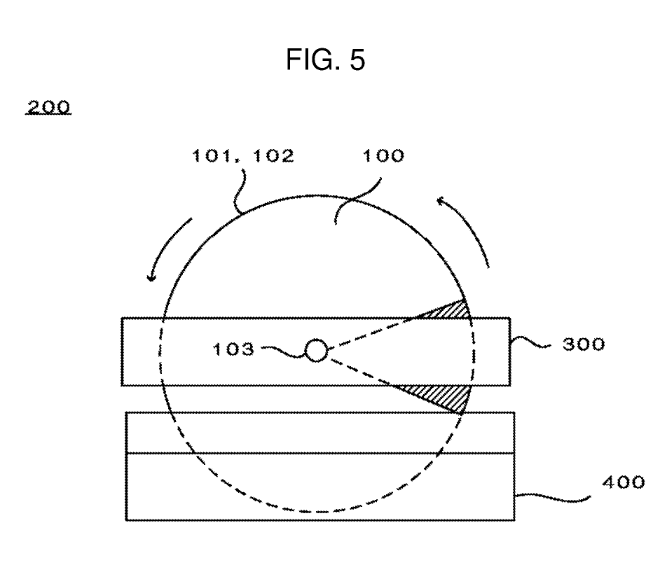

As shown in FIG. 4, magnesium fuel assembly allows separator 102 to impregnate with electrolytic solution by passing through the electrolytic solution in electrolytic solution retainer 400 by rotating with rotating shaft 103 as the center. Subsequently, as shown in FIG. 5, magnesium fuel assembly 100 rotates again to penetrate cathode 300, resulting in separator 102 functioning as the separator for magnesium battery 200, producing ion-exchange in the electrolytic solution and generating electromotive force by oxygen reduction reaction using magnesium contained in magnesium plate 101 as the anode active material. Although not shown in the drawing, with rotating shaft 103 serving as the anode extraction electrode, cathode terminals electrically connected to cathode 300 each extract electricity.

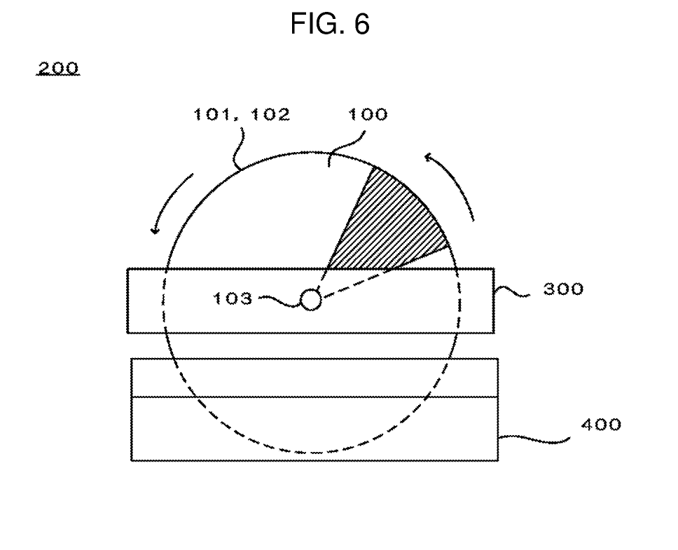

As shown in FIG. 6, magnesium plate 101 consumed by the reaction is extracted from cathode 300 by rotation and, at the same time, the unreacted part of magnesium fuel assembly 100 is inserted into cathode 300.

In this way, magnesium fuel assembly 100 that serves as fuel for magnesium battery 200 is inserted into and extracted from cathode 300 by rotation centered on rotating shaft 103, thus enabling continuous supply of fuel.

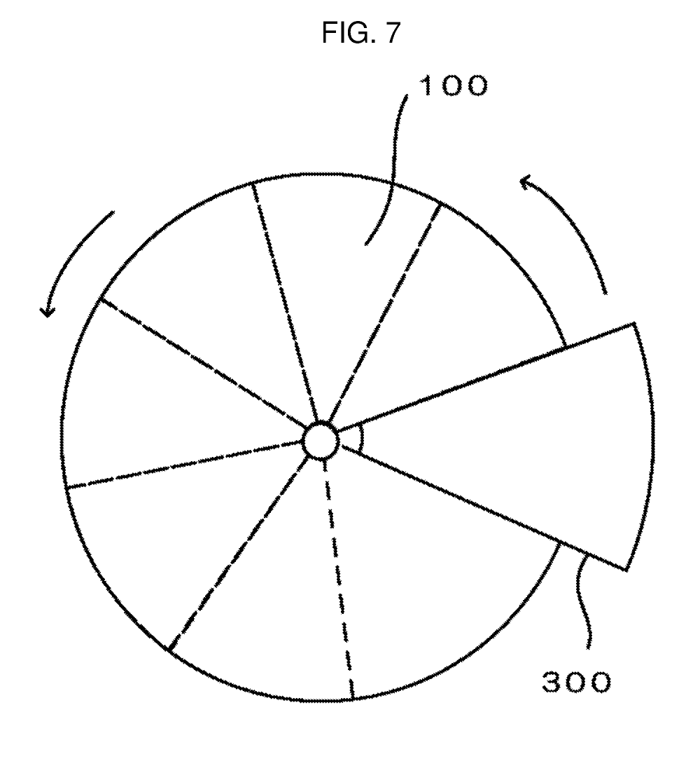

The shapes of cathode 300 may are not limited to those shown in FIGS. 3-6 as long as the size and shape allow insertion of segments of magnesium plate 101. FIG. 7 shows an example in the form of an outline drawing of magnesium battery 200 with a fan-shaped cathode 300 that hides part of magnesium plate 101. In this case, if magnesium plate 101 is disk-shaped, insertion into cathode 300 can be performed efficiently by dividing them into multiple insertions in fan-shapes identical to cathode 300.

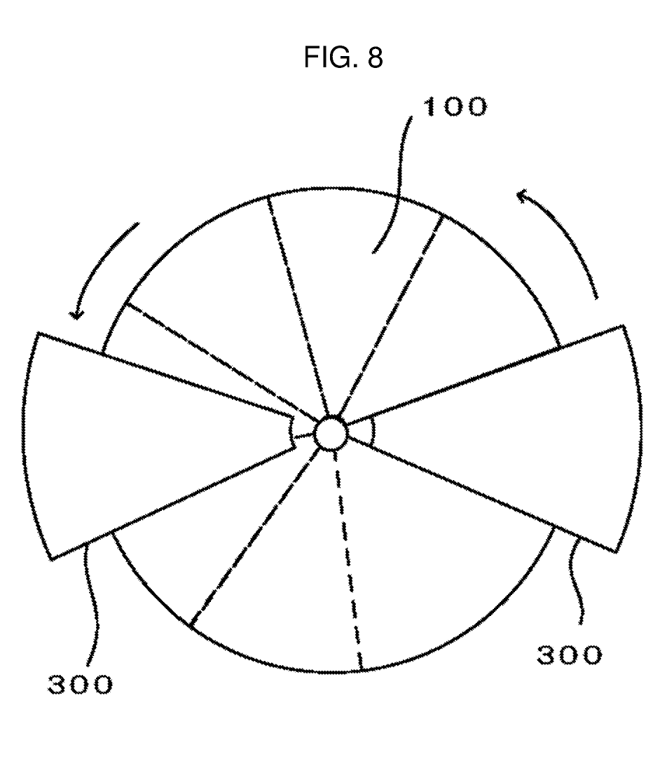

In addition, as shown in FIG. 8, multiple cathodes 300 may be installed. Note that electrolytic solution retainer 400 is omitted from FIGS. 7 and 8.

### Embodiment 2

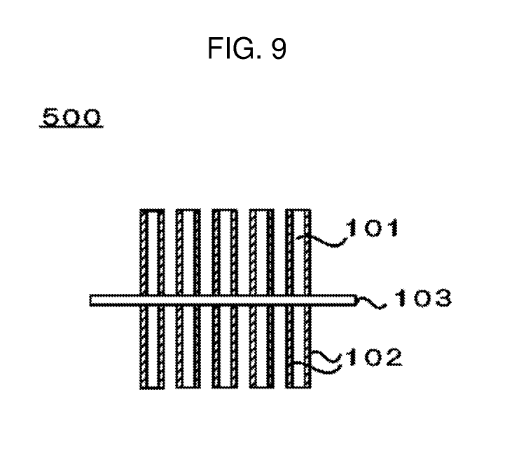

Descriptions that duplicate those for Embodiment 1 are omitted. In magnesium fuel assembly 500 in Embodiment 2, multiple magnesium plates 101 in the magnesium fuel assembly in Embodiment 1 are installed around rotating shaft 103. Magnesium fuel assembly 500 is furnished with magnesium plate 101, separator 102 that encases magnesium plate 101 and rotating shaft 103, with multiple magnesium plates 101 encased in separator 102 installed around rotating shaft 103. This is shown in the cross-sectional side view drawing in FIG. 9. The multiple magnesium plates 101 can be driven simultaneously by rotating shaft 103.

Next, we will describe magnesium battery 600, which uses magnesium fuel assembly 500.

Furnished with cathode 700 and electrolytic solution retainer 400, magnesium battery 600 produces electromotive force using magnesium assembly 500 as fuel.

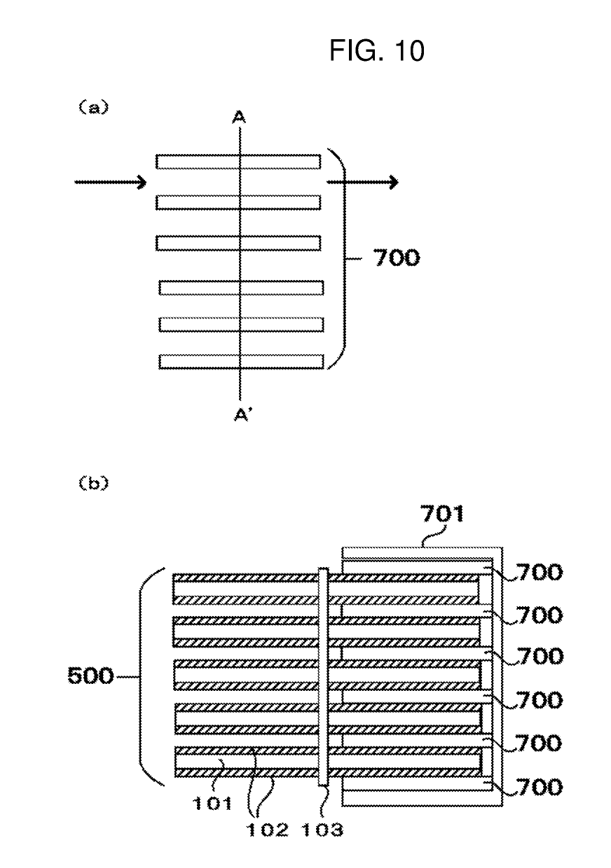

FIG. 10 is a cross-sectional drawing of cathode 700 that shows a view seen from the axial direction of rotating shaft 103 (a) and a cross sectional drawing of point A-A (b). Cathode 700 sandwiches each of the multiple magnesium plates 101 in magnesium fuel assembly 500 from above and below. Here, magnesium plate 101 and separator 102 can be permeated and are arranged to maintain a distance at which cathode 300 can make contact with separator 102. This distance may be fixed for cathode 300 and covering component 701 may be provided to function as a cover. While a number of shapes are possible for cathode 700, like Embodiment 1, a fan shape enables efficient reaction with disk-shaped magnesium plate 101.

In magnesium battery 600, multiple magnesium plates 101 rotate with rotating shaft 103 as the center, so that, like Embodiment 1, after being impregnated with electrolytic solution by electrolytic solution retainer 400, separator 102 is inserted into cathode 700, initiating a cell reaction, and, when magnesium plate 101 has been consumed, it is extracted by repeated rotation and, at the same time, an unreacted magnesium plate 101 is inserted into cathode 700, enabling continuous use.

While this concludes the description of embodiments of the invention, the invention is not limited to the embodiments described above.
100, 500 Magnesium fuel assembly
101 Magnesium plate
102 Separator
103 Rotating shaft
200, 600 Magnesium battery
300, 700 Cathode
301, 701 Covering component
400 Electrolytic solution retainer

In the foregoing specification, embodiments of the invention have been described with reference to numerous specific details that may vary from implementation to implementation. Thus, the sole and exclusive indicator of what is the invention and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A magnesium fuel assembly, comprising:
a separator formed with liquid-absorbable material;
a magnesium plate incorporating magnesium encased in the separator; and
a rotating shaft formed by a semiconductor electrically connected to the magnesium plate, the rotating shaft arranged to penetrate at a point near the center of the magnesium plate, which rotates with the rotating shaft at its center.

2. The magnesium fuel assembly of claim 1, wherein the magnesium plate is formed in a disk shape.

3. The magnesium fuel assembly of claim 1, wherein multiple magnesium plates are arranged so the multiple magnesium plates share the rotating shaft and rotate with the rotating shaft at the center.

4. The magnesium fuel assembly of claim 1, wherein the magnesium plate is formed in a disk shape, and wherein multiple magnesium plates are arranged so the multiple magnesium plates share the rotating shaft and rotate with the rotating shaft at the center.

5. The magnesium fuel assembly of claim 1, further comprising:
an operating device for the rotating shaft.

6. The magnesium fuel assembly of claim 1, further comprising:
an operating device for the rotating shaft;
wherein multiple magnesium plates are arranged so the multiple magnesium plates share the rotating shaft and rotate with the rotating shaft at the center.

7. The magnesium fuel assembly of claim 1, further comprising:
an operating device for the rotating shaft;
wherein the magnesium plate is formed in a disk shape; and
wherein multiple magnesium plates are arranged so the multiple magnesium plates share the rotating shaft and rotate with the rotating shaft at the center.

8. The magnesium fuel assembly of claim 1, further comprising:
an operating device for the rotating shaft;
wherein the operating device comprises a spring wound around an elastic body in a spiral.

9. The magnesium fuel assembly of claim 1, further comprising:
an operating device for the rotating shaft;
wherein the operating device comprises a spring wound around an elastic body in a spiral;
wherein multiple magnesium plates are arranged so the multiple magnesium plates share the rotating shaft and rotate with the rotating shaft at the center.

10. The magnesium fuel assembly of claim 1, further comprising:
an operating device for the rotating shaft;
wherein the operating device comprises a spring wound around an elastic body in a spiral;
wherein the magnesium plate is formed in a disk shape; and
wherein multiple magnesium plates are arranged so the multiple magnesium plates share the rotating shaft and rotate with the rotating shaft at the center.

11. A magnesium battery, comprising:
a separator formed with liquid-absorbable material;
a magnesium plate incorporating magnesium encased in the separator;
a rotating shaft formed by a semiconductor electrically connected to the magnesium plate, the rotating shaft arranged to penetrate at a point near the center of the magnesium plate, which rotates with the rotating shaft at its center;
a cathode arranged so that it contacts the magnesium plate and the separator by sandwiching the magnesium plate and the separator from above and below;
an electrolytic solution retainer that holds electrolytic solution inside;
wherein the magnesium plate that serves as fuel moves by rotation and is impregnated with electrolytic solution in the electrolytic solution retainer, the magnesium plate inserted in the cathode serves as fuel to produce an electromotive force;
wherein after a reaction is caused by the insertion of the magnesium plate, the magnesium plate is extracted from the cathode simultaneously with insertion of an unreacted magnesium plate into the cathode.

12. The magnesium battery of claim 11, wherein the cathode is formed in a fan shape.

13. The magnesium battery of claim 11, further comprising:
a plurality of cathodes.

14. The magnesium battery of claim 11, further comprising:
a plurality of cathodes;
wherein each cathode among the plurality of cathodes is formed in a fan shape.

15. The magnesium battery of claim 11, wherein the magnesium plate is formed in a disk shape.

16. The magnesium battery of claim 11, wherein multiple magnesium plates are arranged so the multiple magnesium plates share the rotating shaft and rotate with the rotating shaft at the center.

17. The magnesium battery of claim 11, wherein the magnesium plate is formed in a disk shape, and wherein multiple magnesium plates are arranged so the multiple magnesium plates share the rotating shaft and rotate with the rotating shaft at the center.

18. The magnesium battery of claim 11, further comprising:
an operating device for the rotating shaft;
wherein the operating device comprises a spring wound around an elastic body in a spiral.

19. The magnesium battery of claim 11, further comprising:
an operating device for the rotating shaft;
wherein the operating device comprises a spring wound around an elastic body in a spiral;
wherein multiple magnesium plates are arranged so the multiple magnesium plates share the rotating shaft and rotate with the rotating shaft at the center.

20. The magnesium battery of claim 11, further comprising:
an operating device for the rotating shaft;
wherein the operating device comprises a spring wound around an elastic body in a spiral;
wherein the magnesium plate is formed in a disk shape; and
wherein multiple magnesium plates are arranged so the multiple magnesium plates share the rotating shaft and rotate with the rotating shaft at the center.
